(19) United States
(12) Patent Application Publication
(10) Pub. No.: US 2018/0299241 A1
(43) Pub. Date: Oct. 18, 2018

(54) Measuring Tape Device with Mechanical Counter

(71) Applicant: Dragan Nikolic, Holiday, FL (US)

(72) Inventor: Dragan Nikolic, Holiday, FL (US)

(73) Assignee: Dragan Nikolic, Holiday, FL (US)

(21) Appl. No.: 15/486,289

(22) Filed: Apr. 12, 2017

(51) Int. Cl. G01B 3/10

(52) U.S. Cl. CPC G01B 3/1061; G01B 2003/1069

(57) ABSTRACT

A measuring tape device with mechanical counter is disclosed. Said invention comprised of a conventional tape measure having a plurality of knob and/or disc type counters arranged on one side. Said counters having metric and imperial indicia allowing a user to spin them and temporarily set them into a desired counting arrangement based upon the measurement observed on the device tape. Counting discs and knobs being temporarily set by means of ball and spring assemblies positioned behind each counter. An object of the invention is to enhance the accuracy and precision of existing, conventional tape measures by allowing users to record measurements gleaned from a tape directly on the device rather than writing it down on a separate piece of paper that may lead to potential recording errors.

### FIELD OF THE INVENTION

The present invention relates generally to measuring tapes and measuring devices of the like. More particularly, the invention relates to a measuring tape device employing means for mechanically recording values, in one or both of metric or standard units. The means for mechanically recording values can be a mechanical counter, such as rotatable counters or disk tumblers having numerical indicia disposed thereon.

### BACKGROUND

Measuring tapes and similar measuring devices are well known in the prior art. Conventional measuring tape devices include a housing which contains a spool of flexible measuring tape. The flexible tape may have one or more combinations of metric or standard delineated markings which typically start at the distal end of a tape, and extends the length of a tape. When measuring objects, the user will extend the distal end of the tape to the desired length, and then record the distance as marked from the distal end, using the desired system of measurement. For standard measuring systems, the delineated markings are typically presented in terms of fractions, with 1/16″ or 1/32″ being the smallest measurement. In metric systems, a millimeter is typically the smallest measurement and is recorded in decimal point notation as opposed to fractions. As such, the user is conventionally directed to the tasks of extending the tape, properly reading the delineated marking, and either remembering or recording the value by writing it on a piece of paper or the like. One skilled in the art will quickly discern that the task of remembering the measured values, even for the most skilled individual, can be quite daunting especially when a plurality of measurements are needed to be accurately taken. Alternatively, if the user is recording the measured values on a piece of paper or other material, the user must take deliberate care to correctly view the measurement and then properly transcribed it.

When employing a conventional measuring tape device, both hands are typically in use, therefore the user is still required to remember the viewed measurement for at least the period of time between deploying the tape for taking the measurement and obtaining a writing implement and surface to write down the value. Again, those skilled in the art will quickly envision the difficulties which may arise if there is a need to measure and subsequently transcribe a large plurality of measurements. As a result, prior art has shown many attempts at measuring devices which aim to solve these problems. A conventional solution seen in many prior art devices has been the incorporation of electronic components to provide a digital display having a fraction or decimal readout of the measured length. This gives the user the option to view, or input into, the digital display, the value as discerned from the delineated markings on the tape. Thus, the user can quickly reference the typically larger display for memorizing or transcribing the measured value.

Examples can be seen in U.S. Pat. Nos. 4,242,574; 4,316,081 and 7,103,988. These and similar devices employ electronic means for discerning and displaying the extended length of the tape, such as sensors or the like. Further, devices employing calculators with keyboards are also known, which allow users to input measurement values for calculations, if needed.

U.S. Pat. No. 7,178,259 disclosed to Williams et al. disclosed a measuring device employing a rolling mechanism for measuring values as opposed to an extendable flexible tape. This device also employs an electronic display (LCD display) for displaying the measured distance for viewing by the user. As can be clearly seen, the employment of electronics and digital displays for measured values is widely used in the art. It seems that the desire for employing such display means is attributed to the fact that the user will now have a means separate from conventional delineated markings, for viewing the measured values for reference later. Users can quickly and easily view and remember complicated fraction or decimal values, without the occurrence of user error from improperly re-reading or remembering the measured lengths from the closely spaced markings on the measuring tape itself. However there exists many inherent downfalls with the many prior art devices which the present invention aims to solve. Firstly, the use of electronics incorporated into these devices generally requires the device to employ batteries, either replaceable or rechargeable. As such, if the battery dies and the user is unable to replace the battery for any reason, or must wait for the battery to be charged, the device will be rendered I inoperable for the intended purposes during that time.

Further, the addition of electronic components to the measuring device will tend to make the device more complex which often results in the device being easily subject to failure. For example, this may occur of the device is dropped or smashed on a job site, and the sensitive electronic components can be easily damaged. Further, if the device is inadvertently submerged in a liquid, the electronics may also fail. Although the provision of displaying measured length values by means which are separate from the conventional closely spaced delineated markings of a tape measure is highly valuable in order to allow users to more quickly and easily reference the length value for memorization or transcription, there has yet to be provided a prior art device which overcomes many of the above noted and other inherent drawbacks of electronic measuring tape devices. As a result, there is a continuing unmet need for a measuring device which provides a means for mechanically recording values, in one or both of metric or standard units. Such a device should employ one or a plurality of mechanical counters, such as rotatable counters, disk tumblers, or the like. Thus, using mechanical recording means, the user is no longer fraught with the downfalls of the incorporation of electronic components or batteries, however is still provided with a means for recording and concurrently displaying values once discerned from the measure tape, or for recording values prior to making measurements.

The foregoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals through the disclosure of a measuring tape device employing means for mechanically recording and displaying measured values, in one or both of metric or standard units of measurement. It is preferred that the means for mechanically recording and displaying measured values is provided by some type of mechanical counter, such as rotatable counters, disk tumblers, or the like (herein referred to in this summary as a counter member).

In accordance with at least one preferred mode, the device comprises a housing containing a conventional measuring tape in a spring loaded spooled engagement, and employs one or a plurality of counter members engaged to the exterior of the housing. Each member employs an annular array of printed, etched, or other numerical indicia in the form of fractions, whole numbers, or decimal values, which can be user-rotated to a registered position for recording and displaying measurement values using their fingers. Small spring assemblies behind each counter allow the members to temporarily lock into a digit. As a first illustrative example, without implying limitations thereon, a set of four counters may be employed, with a first two counters having an indicia array of whole numbers from 0-9 representing a ‘feet’ (′) measurement or an inches (″) measurement, a third counter having an array of whole numbers from 0-11 representing ‘inches’ (″) measurement, and a fourth counter having an indicia array of fractions from 0-1,″ 1/32,″ 1/16,″ ⅛,″ ¼″ or ¾″ increments—representing ‘fractions of inches’ values. Each counter may have a registration marking disposed adjacent the counter, such that the user can align the desired values with the registration marking, to record a length measurement value. For example, if a measurement of 6′-2 ¾″ is determined from the measuring tape, or is the desired length to be measured out, instead of memorizing this or frantically trying to write it down on a piece of paper, the user can turn the first counter to 6, the second to 2, and the third to ¾, to record and display that measurement as a quick and easy reference. It is noted and anticipated that the quantity and increments of each know may be different than described above. For example the foot measurement counter may go to more or less than 9, and the fractions measurement counter can be in increments of 1/32, 1/16, ⅛, ¼or other suitable value. In addition, other modes are envisioned wherein the mechanical recording and displaying means provided by mechanical counters may have indicia for metric system unit of measurement employing decimal meter values. Similar to the example as described above, a first counter in a set of three or more may be employed to represent the ‘tens’ position, a second know the ‘one's’ position, a third counter for the ‘tenths’ position, a fourth for the ‘hundredths’ position, and so forth, each having an array of numerical indicia of whole numbers from 0-9.

Still further, it is within the scope of the invention that other types of mechanical counters providing the mechanical recording means may be employed and are anticipated. For example, one or a plurality of disc tumblers, similar to those seen in briefcase locks, having numerical indicia may be employed. In accordance with yet another preferred mode, the mechanical recording and displaying means can be removably engageable for the measuring tape housing, thus allowing the user to remove and replace components from metric to standard units, and vis versa, or replace the counters having different increments of numerical indicia, as needed. Still further, it is anticipated that the provision of such means for mechanically recording and displaying measurement values can be employed on any measuring device, even those which may or may not employ conventional flexible measuring tape.

An object of the aforementioned invention is to enhance the accuracy and precision of a conventional tape measuring device.

Another object of the aforementioned invention is to temporarily record measurements observed on a measuring tape on said measuring tape device.

Another object of the aforementioned invention is to temporarily record imperial and/or metric measurements observed on said measuring tape device.

Another object of the invention is to employ a mechanical means for recording measurements using rotating disc and/or knob assemblies that can be set using finger motions.

Another object of the invention is to have said recording assemblies within easy reach of those using the device on a side of said device.

Another object of the invention is to allow users to record various increments of a measurement upon different counter members.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 is a perspective view of the invention with metric counter dials.

FIG. 2 is a plan view of a metric counter dial

FIG. 3 is a perspective view of the invention with metric counter discs.

FIG. 4 is a plan view of a metric counter disc,

FIG. 5 is a perspective view of the invention with imperial counter dials.

FIG. 6 is a plan view of an imperial counter dial.

FIG. 7 is a section view A-A of an imperial counter dial

FIG. 8 is a perspective view of the invention with imperial counter discs.

FIG. 9 is a front view of an imperial disc counter.

FIG. 10 is a section view C-C of a counter disc with rod spring assembly.

FIG. 11 is a section view B-B of a counter disc with a ball spring assembly.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

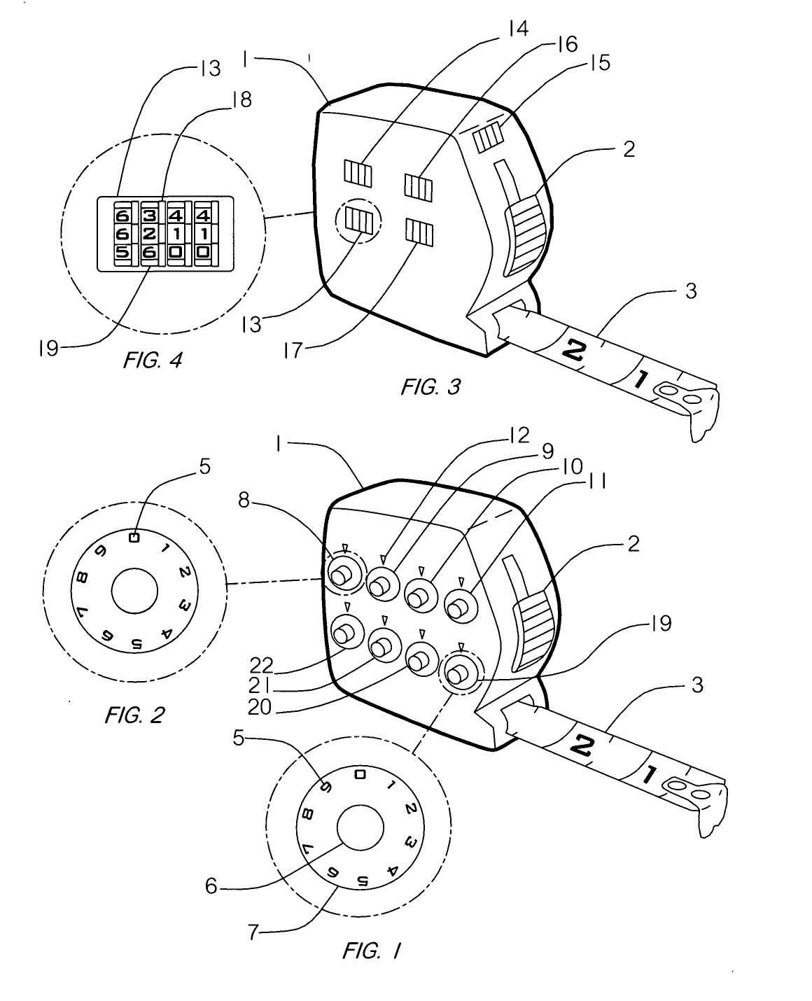

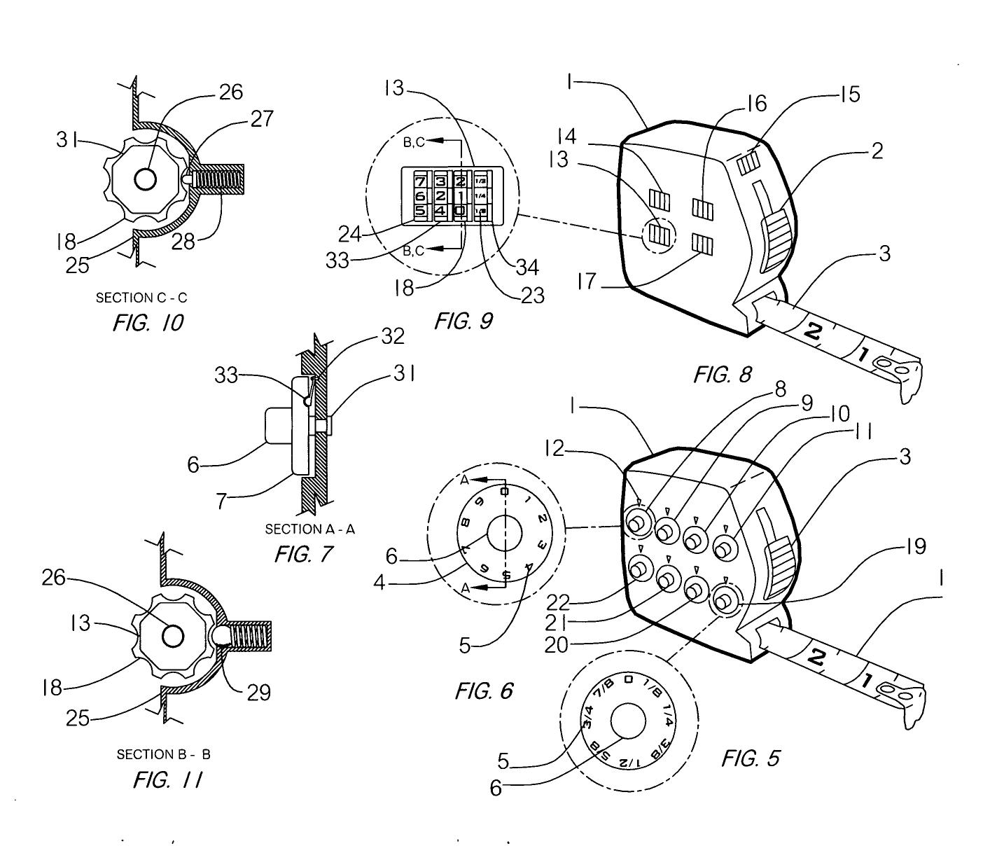

FIG. 1 being a preferred mode of a metric measuring tape device 1 comprising a square-shaped housing made of, but limited to, a rigid material such as plastic and metal etc. for containing a conventional measuring tape spooled engagement 3 or other suitable engagement and having a tape thumb locking lever 3. In this mode the means for mechanically recording and displaying length values is provided by one or a plurality of counter dials 8-11 and 19-22. Said dials being arranged in a linear fashion in groups of two, but not limited to, four members having a planar, circular outlined base with a protruding knob 6 and being made of a rigid material such as metal and plastic etc. and engaging to at least one exterior sidewall of the device 1. As clearly shown, each counter 8-11 and 19-22 employs an annular array of numerical indicia 5 in the form of, but not limited to, whole numbers, fractions, or decimal values etc. Adjacent to each counter is a registration marking 12 allowing the user to align the desired metric indicia 5 values (shown in FIG. 2) with the registration marking 12 for recording a length value. As is clearly shown, a first set of a plurality of counters 8-11 and 19-22 may be provided for standard unit of measurements, as feet, inches, and fractions of inches, while a second set of counters 13-17 (shown in FIG. 3) may be provided for metric unit of measurements, in meters (1.0 m), tenths of meters (0.1 m), and hundredths of a meter (0.01 m). However, it is noted and anticipated that less or additional sets of counters 13-17 shown in FIG. 4 may be engaged to device 1 and employed to allow the user to record multiple values, if desired. Further, it is within the scope of the invention that one or all of the sets of counters 8-11 and 19-22 or 13-17 can be in either metric or standard units of measurement, as deemed suitable by the designer. As such the depictions shown in the figures should be considered illustrative and not limiting. FIG. 3 also showing another embodiment with at least four counting dials 14-17 arranged in, but not limited to, groups of four arranged in a linear configuration on a side of said device 1. FIG. 7 showing a section view of said dial 6 being affixed to device 1 by means of shaft 31 having a loose fit allowing said dial 6 to be rotated. Dial 6 also being temporarily held in a selectively, stationary position by a spring arm 32 operatively attached to device 1. Said spring 32 having one end adapted in a spherical shape and engaging small orifices located radially at each indicia and inset on the backside of said dial 6.

As a first illustrative example of an as-used mode of the invention, shown in FIG. 9, without implying limitations thereon, a first set of three counters 13 is shown having indicia 23 for standard units. The first two counters depict indicia 24 and 33 showing whole numbers from 0-9 representing a ‘feet’ measurement (′) or an ‘inches’ measurement (″), a third counter 18 having an array of whole numbers from 0-11 representing ‘inches’ measurement, and a fourth counter 34 having an indicia array of fractions from 0-1, in increments of ¼ inch, representing ‘fractions of inches’ values. As shown, one skilled in the art can clearly discern that the displayed length value is 621′ ¼″.

It is noted and anticipated that the quantity and increments of each counter 13-16 may be different than that shown, for example the foot measurement counter 13 may go to more or less than 9, and the fractions measurement counter 34 can be in increments of 1/32, 1/16, ⅛, ¼or other suitable value. In addition, as shown, a second set of counters in FIGS. 4 and 2 are provided as counters in metric units of measurement. The first counter in FIG. 1 depicts indicia 5 showing whole numbers from 0-9 representing a ‘meters’ (1.0 m), a second counter 9 and third counter 10 having an indicia 5 array of whole numbers from 0-9 representing ‘tenths of a meter’ (0.1 m, centimeters), and a fourth counter 19 having an indicia 5 array of whole numbers from 0-9 representing ‘hundredths of a meter’ (0.01 m, millimeter). In accordance with yet another preferred mode the device 1 employing one or a plurality of removably engageable disc or dial counters may be provided, which allows the user to replace counters having indicia of different increments, values, or to configure the device 1 to one or both of metric or standard unit system. In the current mode, the means for removable engagement for the dials is provided by a post 31 which the counters can be snap-fit or frictionally engaged to. However it is noted that other means for removable engagement which one skilled in the art will envision as suitable for the intended purpose may be employed and are anticipated, for example set screws may be employed.

FIG. 10 showing a section view of said counter disc assembly having an axle 26 and temporarily and selectively engagement with said disc member 18 into a fixed position by means of a rod spring assembly 27 that extends into grooves adapted to receive said rod 27. Said pin being compressed and allowing disc 18 to disengage and be turned under normal finger loads expressed by a user. FIG. 11 alternatively showing a section view of said counter disc assembly having a temporarily and selectively engagement with said disc member 18 into a fixed position by means of a ball spring assembly 29 that extends into grooves adapted to receive said ball 29. Once again, said ball being compressed and allowing disc 18 to disengage and be turned under normal finger loads expressed by a user.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A measuring tape device with mechanical counter having one or a plurality of mechanical counters as a means for mechanically recording and displaying length values.

2. The device of claim one providing an enhancement to the accuracy and precision of a conventional tape measuring device.

3. The device of claim one providing a temporary means of recording measurements observed on a measuring tape within said device.

4. The device of claim one providing a means to temporarily record imperial and/or metric measurements observed on said measuring tape device.

5. The device of claim one providing a mechanical means for recording measurements using rotating disc and/or knob assemblies that can be set using finger motions.

6. The device of claim one providing recording assemblies within easy reach of those using the device on a side of said device.

7. The device of claim one providing allowing users to record various increments of a measurement upon different counter members.
